(19) United States
(12) Patent Application Publication
(10) Pub. No.: US 2006/0109355 A1
(43) Pub. Date: May 25, 2006

(54) Mobile communication terminal having a camera function and a method for implementing the camera function

(75) Inventor: Woo-Sun Yoon, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/116,312

(22) Filed: Apr. 28, 2005

(30) Foreign Application Priority Data
Nov. 23, 2004 (KR) 2004-96341

(51) Int. Cl. H04N 5/228; H04N 5/262

(52) U.S. Cl. 348/240.99

(57) ABSTRACT

An apparatus and method are provided for implementing a camera function of a mobile communication terminal having a zooming function capable of enlarging or reducing an image. The apparatus and method include storing zooming levels of a camera such that the zooming levels are mapped to preset shutter speeds on a one-to-one basis, detecting a shutter speed corresponding to a requested zooming level in response to a user's request for zooming level control in a camera mode, and photographing an image according to the detected shutter speed upon the input of a shutter key for an image photographing operation of the camera. Therefore, it is possible to photograph an image at a constant brightness by varying a shutter speed according to the zooming level of a camera.

### PRIORITY

This application claims the benefit under 35 U.S.C. § 119(a) of an application entitled “Mobile Communication Terminal Having Camera Function and Method for Implementing the Camera Function” filed in the Korean Intellectual Property Office on Nov. 23, 2004 and assigned Serial No. 2004-96341, the entire contents of which are incorporated herein by reference.

### BACKGROUND OF THE INVENTION

1. Field of the Invention

The present invention relates generally to a mobile communication terminal having a camera function. In particular, the present invention relates to a mobile communication terminal having a zooming function capable of enlarging or reducing an image, in which an image can be photographed at a constant brightness regardless of a zooming ratio during a zooming operation of a camera, and a method for implementing the camera function.

2. Description of the Related Art

A mobile communication terminal provides a user with communication functions which allow the user to have conversations or exchange data while the user is moving. The mobile communication terminal comprises a cellular phone, a personal digital assistant (PDA), a personal communication service (PCS) phone, an International Mobile Telecommunication-2000 (IMT-2000) terminal, and a Global System for Mobile communication (GSM) terminal.

Such a mobile communication terminal has come into wide use all over the world and there is now a growing recognition that a mobile communication terminal is a necessity. As a result, a mobile communication terminal tends to be small, slim, and lightweight to make it easy for users to carry and is evolving into a multimedia device that can provide additional functions. In particular, a future mobile communication terminal will be smaller, have multiple functions and purposes, and evolve to be adapted to various multimedia environments or Internet environments.

At present, a mobile communication terminal is being transformed into a configuration capable of providing high-speed data communication in addition to voice communication. Such high-speed data communication and voice communication can be achieved through the implementation of an IMT-2000 mobile communication network. A mobile communication terminal that performs such data communication can process packet data and video data. In addition, a mobile communication terminal can display moving pictures via a camera or a TV receiver. Thus, a mobile communication terminal having a camera can photograph an image, display the photographed image as a moving or still picture, and transmit the photographed image screen. Moreover, the mobile communication terminal having a camera has a zooming function capable of enlarging or reducing a photographed image.

A mobile communication terminal having a zooming function (e.g., 3× or 5× optical zooming) usually provides 6- or 7-level zooming control from WIDE (preview state) to TELE. However, since a shutter speed (i.e., the amount of time a shutter is being opened) is predetermined regardless of such zooming control, as a zooming ratio increases, i.e., as the camera zooms towards the TELE zoom position, a distance between a lens and a camera sensor that is a charge coupled device (CCD) increases and the brightness of light reaching the camera sensor reduces. Thus, there is a problem that as the zooming ratio increases, the brightness of light reaching the camera sensor reduces and the photographed image is displayed slightly dark.

### SUMMARY OF THE INVENTION

It is, therefore, an object of the present invention to provide a mobile communication terminal in which an image can be photographed at a constant brightness regardless of a zooming ratio during a zooming operation of a camera, and a method for implementing the camera function.

To achieve the above and other objects, there is provided a method for implementing a camera function of a mobile communication terminal having a zooming function capable of enlarging or reducing an image. The method includes storing zooming levels of a camera such that the zooming levels are mapped to preset shutter speeds on a one-to-one basis; detecting a shutter speed corresponding to a requested zooming level in response to user's request for zooming level control in a camera mode; and photographing an image according to the detected shutter speed upon the input of a shutter key for an image photographing operation of the camera.

To achieve the above and other objects, there is also provided a mobile communication terminal having a zooming function capable of enlarging or reducing an image. The mobile communication terminal comprises a camera module, a memory, and a controller. The camera module has a lens unit that can be pulled in and out and for photographing an image through the lens unit. The memory stores a table in which zooming levels of the lens unit are mapped to preset shutter speeds on a one-to-one basis. The controller detects a shutter speed corresponding to the requested zooming level from the memory in response to user's request for zooming level control and controls the camera module to photograph an image according to the detected shutter speed upon the input of a shutter key for image photographing.

Preferably, the mobile communication terminal comprises a display unit for displaying the requested zooming level and the shutter speed corresponding to the requested zooming level under the control of the controller.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a mobile communication terminal according to an embodiment of the present invention, viewed from the top;

FIG. 2 is a side view of a mobile communication terminal according to an embodiment of the present invention, viewed from the top;

FIG. 3 is a schematic block diagram of a mobile communication terminal according to an embodiment of the present invention;

FIGS. 4A and 4B illustrate a zooming level of a camera included in a mobile communication terminal according to an embodiment of the present invention; and

FIG. 5 is a flowchart illustrating a process of implementing a camera function of a mobile communication terminal according to an embodiment of the present invention.

Throughout the drawings, the same element is designated by the same reference numeral or character.

### DETAILED DESCRIPTION OF AN EXEMPLARY EMBODIMENT

Preferred of the present invention will now be described in detail with reference to the accompanying drawings. In the drawings, the same or similar elements are denoted by the same reference numerals even though they are depicted in different drawings. In the following description, a detailed description of known functions and configurations incorporated herein has been omitted for conciseness.

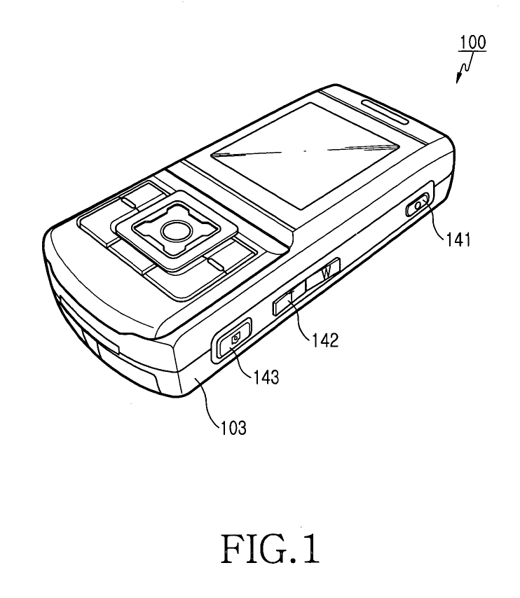

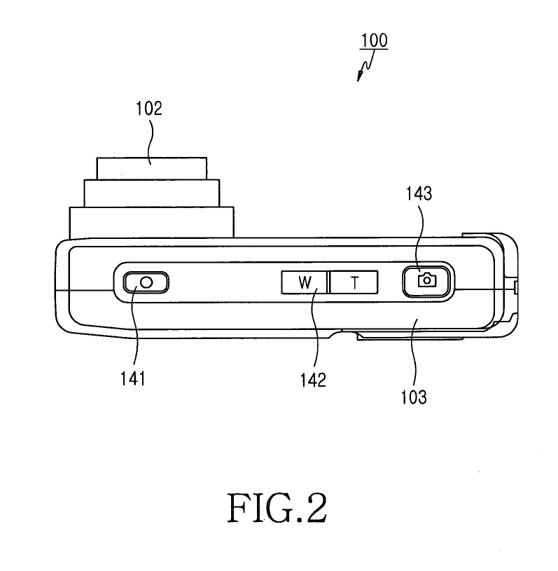

FIG. 1 is a perspective view of a mobile communication terminal according to an embodiment of the present invention, viewed from the top, and FIG. 2 is a side view of a mobile communication terminal according to an embodiment of the present invention, viewed from the top.

Referring to FIGS. 1 and 2, in a mobile communication terminal 100, an optical zoom camera lens module 102 is positioned in the lower portion of a main body, and camera operation keys, i.e., a camera power key 141 used when the mobile communication terminal 100 enters a camera mode, a zoom key 142 used to control a zooming level (i.e., a zooming ratio) of the optical zoom camera lens module 102, and a shutter key 143 used when an image is photographed are positioned in a side 103 of the main body.

The optical zoom camera lens module 102 is a zoom lens portion where a zooming level of a lens is controlled, which moves in and out by the zoom key 142. For the zoom key 142, “W” represents WIDE and “T” represents TELE. Once the mobile communication terminal 100 is switched to a camera mode at a user's request, it enters a wide state, i.e., a preview state (a level at which the zooming ratio is 0). In this state, once a user presses the “T” key, the zooming operation starts and the image is displayed enlarged. The zooming level is generally divided into 6 or 7 levels. However, it should be appreciated by those skilled in the art that the present invention is not limited to 6 or 7 levels.

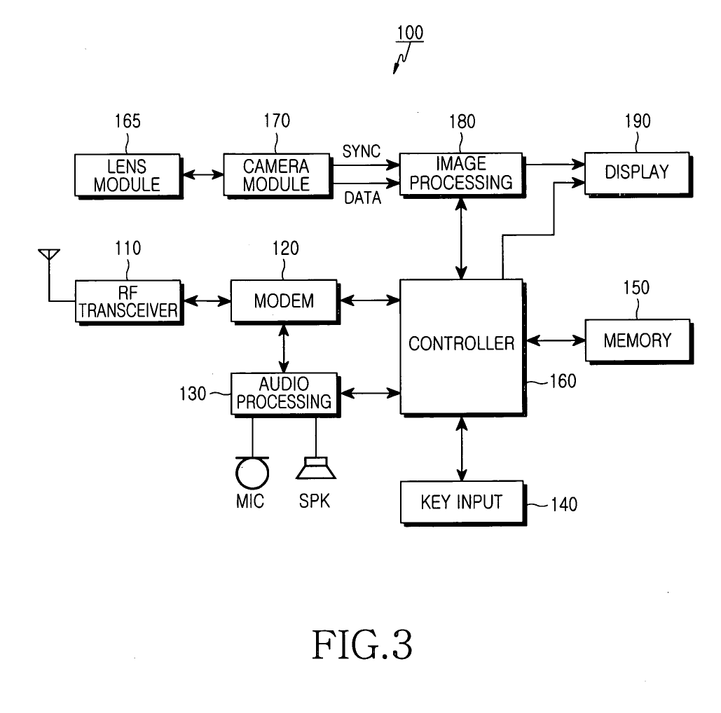

FIG. 3 is a schematic block diagram of a mobile communication terminal according to an embodiment of the present invention.

A mobile communication terminal 100 includes a radio frequency (RF) transceiver 110, a modem 120, an audio processor 130, a key input unit 140, a memory 150, a controller 160, a lens unit 165, a camera module 170, a video/image processor 180, and a display unit 190.

The RF transceiver 110 transmits and receives audio data, character data, video data, and control data under the control of the controller 160. To this end, the RF transceiver 110 includes an RF transmitter (not shown) for up-converting a frequency of a transmission signal and amplifying the up-converted transmission signal and an RF receiver (not shown) for low-noise-amplifying a received signal and down-converting a frequency of the low-noise-amplified signal.

The modem 120 includes a transmitter (not shown) for encoding and modulating the transmission signal and a receiver (not shown) for demodulating and decoding the received signal.

The audio processor 130 can comprise a codec that includes a data codec for processing packet data and an audio codec for processing audio signals such as voice.

The audio processor 130 modulates an electrical signal input from a microphone to convert the modulated electrical signal into audio data and demodulates encoded audio data input from the RF transceiver 110 into an electrical signal to output the electrical signal to a speaker. It is preferable that the audio processor 130 includes a codec for converting a digital audio signal received from the RF transceiver 110 into an analog audio signal and reproducing the analog signal or converting an analog audio signal generated from a microphone into a digital audio signal. The codec includes a data codec for processing packet data and an audio codec for processing audio signals such as voice. Alternatively, the codec may be included in the controller 160.

The key input unit 140 has a key matrix structure (not shown) and includes character keys, number keys, function keys, and external volume keys to output a key input signal corresponding to a key input by a user to the controller 160. The key input unit 140 further includes camera operation keys as shown in FIG. 1 at predetermined positions, i.e., a camera power key 141 used to enter a camera mode, the zoom key 142 used to control a zooming level (i.e., a zooming ratio), and the shutter key 143 used to photograph an image.

A memory 150 can comprise program memories and data memories and stores various information for controlling the operation of the mobile communication terminal 100 according to an embodiment of the present invention and other information selected based on user selection information. The memory 150 can store programs for controlling the lens unit 165 in a camera mode according to an embodiment of the present invention and stores a shutter speed that is preset for each zooming level of the lens unit 165 in a table form as shown in Table 1.

TABLE 1

| | Zooming level | | | | | | |
|---|---|---|---|---|---|---|---|
| | 1 | 2 | 3 | 4 | 5 | 6 | 7 |
| Shutter | 1/30 | 1/25 | 1/20 | 1/15 | 1/12 | 1/10 | ⅛ |
| speed | sec | sec | sec | sec | sec | sec | sec |

Referring to Table 1, the zooming level is divided into a total of 7 levels, and a shutter speed is 1/30 second at a zooming level 1, 1/25 second at a zooming level 2, 1/20 second at a zooming level 3, 1/15 second at a zooming level 4, 1/12 second at a zooming level 5, 1/10 second at a zooming level 6, and ⅛ second at a zooming level 7. In Table 1, as the zooming level increases towards the zooming level 7, an image is enlarged more at a high zooming ratio. As can be seen from Table 1, as the zooming level of the camera goes to the zooming level 7 at which an image to be photographed is enlarged, a shutter speed is set lower. The zooming level is divided into a total of 7 levels in an embodiment of the present invention, but the present invention is not limited thereto.

The controller 160 controls overall operations of the mobile communication terminal 100 according to an embodiment of the present invention. The controller 160 stores the zooming levels of the lens unit 165 in the memory 150 such that the zooming levels are mapped to preset shutter speeds on a one-to-one basis and, at a user's request for zooming level control, detects a shutter speed corresponding to the requested zooming level from the memory 150.

Once the shutter key 143 for an image photographing operation of the camera module 170 is input, the controller 160 controls the camera module 170 to photograph an image according to the detected shutter speed.

The camera module 170 includes the lens unit 165 that can be pulled in and out and photographs an image through the lens unit 165.

The camera module 170 includes a camera sensor for converting photographed optical signals into electrical signals and a signal processor for converting analog signals photographed by the camera sensor into digital data.

Herein, the camera sensor is assumed to be a charge coupled device (CCD) sensor, and the signal processor can be implemented with a digital signal processor (DSP). Optionally, the camera sensor and the signal processor can be implemented into a single unit or can be separately implemented.

The video processor 180 generates screen data for displaying video signals output from the camera module 170.

The video processor 180 processes the video signals output from the camera module 170 frame by frame, and matches the frame video data to the characteristic and size of the display unit 190. The video processor 180 includes a video codec, and compresses the frame video data displayed on the display unit 190 or decompresses compressed frame video data to the original frame video data.

It is assumed that the video processor 180 includes an on-screen display (OSD) function and can output OSD data according to the size of a displayed screen under the control of the controller 160.

The display unit 190 may be a liquid crystal display (LCD), and outputs various display data generated in the mobile communication terminal 100. Here, when the LCD is implemented with a touch screen, the display unit 190 may also serve as an input unit.

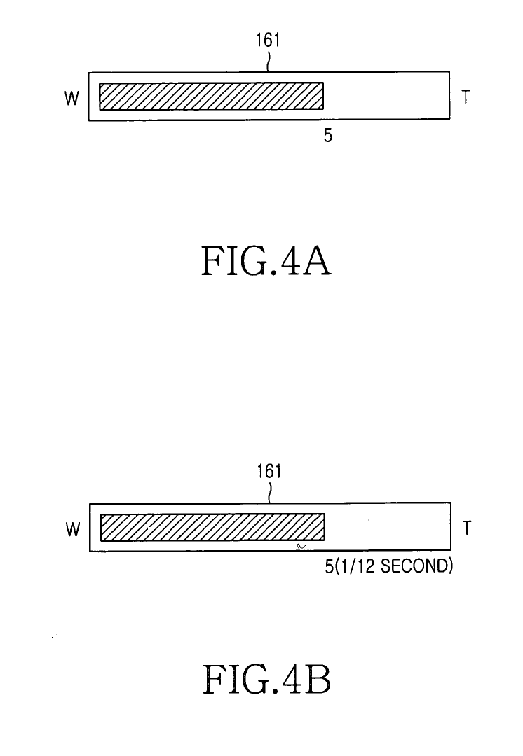

The display unit 190 displays video signals output from the video processor 180 on a screen and displays user data output from the controller 160. The display unit 190 can display the requested zoom level and a shutter speed corresponding thereto under the control of the controller 160 according to an embodiment of the present invention, as shown in FIG. 4B.

FIGS. 4A and 4B illustrate a zooming level of a camera included in a mobile communication terminal according to an embodiment of the present invention.

Referring to FIG. 4A, an indicator 161 shows a user a process of changing a zooming level of the lens unit 165 over a total of 7 levels upon the input of the zoom key 142 of FIG. 1. It can be seen from FIG. 4A that the zooming level is 5.

Referring to FIG. 4B, whenever a user inputs the zoom key 142 for zooming level control, the indicator 161 shows a shutter speed corresponding to the zooming level to the user. It can be seen from FIG. 4B that the zooming level is 5 and a shutter speed corresponding thereto is ½ second.

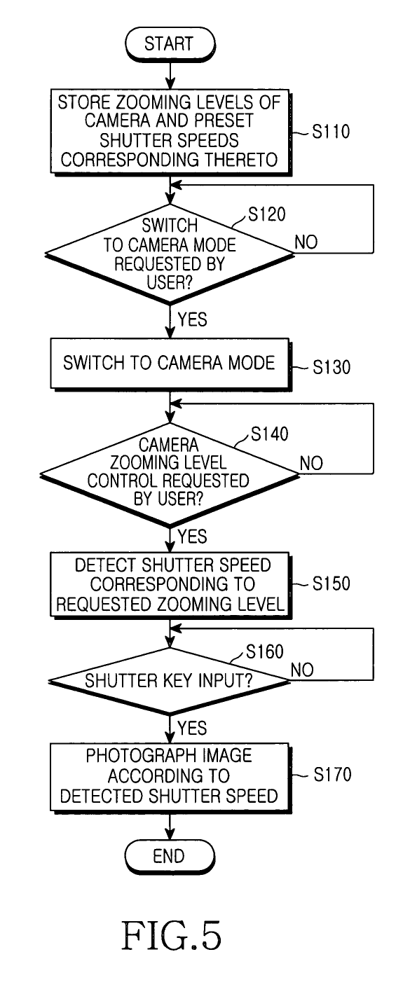

FIG. 5 is a flowchart illustrating a process of implementing a camera function of a mobile communication terminal according to an embodiment of the present invention.

Referring to FIGS. 3 and 5, the controller 160 stores zooming levels of the lens unit 165 connected to the camera module 170 in the memory unit 150 such that the zooming levels are mapped to preset shutter speeds on a one-to-one basis in step S110. The preset shutter speeds stored in the memory 150 are set lower as the zooming level of the lens unit 165 goes to a level at which an image to be photographed is enlarged (i.e., a zooming level with a high zooming ratio). Such setting is intended to increase the amount of light delivered to the camera module 170 by increasing the amount of time the shutter is being opened.

The controller 160 checks if there is a user request to switch to a camera mode (e.g., voice input, the input of a key that is set for switching to the camera mode, or the input of a menu key) in step S120 and, if there is user's request for the switch to the camera mode, switches the mobile communication terminal 100 to the camera mode in step S130.

The controller 160 checks if there is a user request for zooming level control (e.g., zoom key input) in the camera mode in step S140.

If there is a user request for zooming level control, the controller 160 detects a shutter speed corresponding to the requested zooming level from the memory 150 in step S150.

For example, if the user inputs the zoom key 142 to set the zooming level of the lens unit 165 to the zooming level 5, the controller 160 detects the shutter speed 1/12 second corresponding to the zooming level 5 from Table 1 stored in the memory 150. At this time, the controller 160 may display the requested zooming level and the shutter speed corresponding thereto through the display unit 190 as shown in FIG. 4B.

The controller 160 checks if the user inputs the shutter key 143 for image photographing of the camera module 170 in step S160, and if the shutter key 143 is input, controls the camera module 170 to photograph an image according to the detected shutter speed (e.g., 1/12 second).

As described above, according to an embodiment of the present invention, a user of a mobile communication terminal can photograph an image at a constant brightness by controlling the shutter speed according to the zooming level of the lens unit 165.

Therefore, according to an embodiment of the present invention, it is possible to photograph an image at a constant brightness by varying a shutter speed according to the zooming level of a camera.

While the invention has been shown and described with reference to a certain embodiment thereof, it will be understood by those skilled in the art that various changes in form and details may be made therein without departing from the spirit and scope of the invention. In particular, a mobile communication terminal having a camera is taken as an example in the present invention, but the present invention can also be applied to a digital camera. Therefore, the scope of the present invention should not be limited by the above-described exemplary embodiment, but should be defined by the appended claims and their equivalents.

What is claimed is:

1. A method for implementing a camera function of a mobile communication terminal having a zooming function capable of enlarging or reducing an image, the method comprising the steps of:
storing zooming levels of a camera such that the zooming levels are mapped to preset shutter speeds on a one-to-one basis;
detecting a shutter speed corresponding to a requested zooming level in response to a user's request for zooming level control in a camera mode; and
photographing an image according to the detected shutter speed upon the input of a shutter key for an image photographing operation of the camera.

2. The method of claim 1, wherein the preset shutter speeds are set lower as the zooming level of the camera goes to a level at which an image to be photographed is enlarged.

3. The method of claim 1, wherein the detection step comprises the step of displaying the requested zooming level and the shutter speed corresponding to the requested zooming level on a screen of the mobile communication terminal.

4. The method of claim 3, wherein the screen comprises a liquid crystal display.

5. The method of claim 1, wherein the screen comprises an input unit.

6. The method of claim 1, wherein the step of detecting further comprises:
retrieving the correlation between the shutter speed and the zooming levels from a table.

7. The method of claim 6, wherein the table comprises seven levels.

8. The method of claim 1, wherein the zoom level is adjusted via a zoom key.

9. The method of claim 1, wherein the shutter speed is adjusted via a shutter key.

10. A mobile communication terminal having a zooming function capable of enlarging or reducing an image, the mobile communication terminal comprising:
a camera module having a lens unit that can be pulled in and out and for photographing an image through the lens unit;
a memory for storing a table in which zooming levels of the lens unit are mapped to preset shutter speeds on a one-to-one basis; and
a controller for detecting a shutter speed corresponding to the requested zooming level from the memory in response to a user's request for zooming level control and controlling the camera module to photograph an image according to the detected shutter speed upon the input of a shutter key for image photographing.

11. The mobile communication terminal of claim 10, wherein the preset shutter speeds are set lower as the zooming level of the camera goes to a level at which an image to be photographed is enlarged.

12. The mobile communication terminal of claim 10, further comprising a display unit for displaying the requested zooming level and the shutter speed corresponding to the requested zooming level under the control of the controller.

13. The mobile communication terminal of claim 12, wherein the display unit comprises a liquid crystal display.

14. The mobile communication terminal of claim 13, wherein the screen comprises an input unit.

15. The mobile communication terminal of claim 10, wherein an adequate amount of light is allowed into the camera during a zooming operation.

16. The mobile communication terminal of claim 10, wherein the table comprises seven levels.

17. The mobile communication terminal of claim 10, wherein the zoom level is adjusted via a zoom key.

18. The mobile communication terminal of claim 10, wherein the shutter speed is adjusted via a shutter key.
